(19) United States
(12) Patent Application Publication
(10) Pub. No.: US 2015/0367505 A1
(43) Pub. Date: Dec. 24, 2015

(54) SET OF MECHANICAL MEANS THAT CAN BE INCORPORATED INTO A DELTA ROBOT FOR LINING ENDS

(71) Applicant: MATRIRUIZ S.L., Molina de Segura, Murcia (ES)

(72) Inventors: Antonio RUIZ GARCIA, Murcia (ES); Juan José RUIZ PUCHE, Murcia (ES)

(73) Assignee: Matriruiz, S.L., Murcia (ES)

(21) Appl. No.: 14/766,717

(22) PCT Filed: Jan. 8, 2014
(86) PCT No.: PCT/ES2014/000003

§ 371 Date: Aug. 7, 2015

(30) Foreign Application Priority Data
Feb. 8, 2013 (ES) U201300141

(51) Int. Cl. B25J 9/00; B25J 15/00; B25J 19/00; B08B 3/02

(52) U.S. Cl. CPC B25J 9/009; B08B 3/02; B25J 15/0019; B25J 19/0075; B25J 9/0009; Y10S 901/23

(57) ABSTRACT

The invention relates to a set of mechanical means specifically designed to be incorporated into a delta robot, forming a machine that can gum lids at a much greater speed than those traditionally used and with substantially greater efficiency. In some cases, the machine is defined by a pair of arms, the ends of which includes a rectangular machined zone housing a stop element that provides a connection with a bolt. In some cases, the bearings are inserted on both sides of the machined zone by means of a bore-hole characterised in that it extends from the inner portion outwards, such that the hole is not a through-hole along its entire length and the bearings abut against the outer wall of the arm.

### OBJECT OF THE INVENTION

The present invention, as expressed in the title of this specification, refers to a set of mechanical means specifically designed to be incorporated into a delta robot, so that the advantages offered by this delta robot can be used for lining ends. Incorporating said mechanical means thus results in a machine capable of lining shaped ends at a rate much higher than with traditional methods and with slightly higher performance levels.

More specifically, the mechanical means that are incorporated consist of replacing the three articulated arms of the traditional delta robot with others that incorporate precision bearings inserted into the arms through a bore made on the inside so that said bearings are flush with the bolt passing through the rod and thus form a joint that does not suffer from friction and has no play, conditions that are necessary to enable a process in which speed is one of the critical factors.

### SCOPE OF APPLICATION OF THE INVENTION

The present invention will find application in the manufacture of all kinds of metal containers, where the ends have to be lined before they are finally fitted to the container.

Owing to the specifications of the present invention, it will also be possible to find applications in many different types of industrial processes that have in common the need for high speed and high precision.

### BACKGROUND OF THE INVENTION

The lining process is defined herein as the application on the seaming panel or bottom of a metal end (regardless of its geometry) of a bead of compound which is subsequently dried in an oven to a plastic consistency that acts as a seal, ensuring the container is sealed once it is closed.

At present, the machines that perform lining work on ends for the canning industry are found on the market in three types:
Die stamping, where the ends are placed against one or more dies having the shape of the perimeter of the end and which are dipped in a vessel containing the compound. The die presses on the end and leaves the bead ready for drying in the oven.
   Such machines usually suffer from significant problems in that the compound usually dries in the dies and very often stains the end, requiring thorough cleaning maintenance.
Shower, where the die in this case acts as a shower on the seaming of the end. It has a series of small adjacent holes forming the shape of the end, obstructed by needles that insert small drops on the end as they are moved. The shower is supplied from a pressurised main tank. The application quality of this type of machine is better than the previous system. However, maintenance is more complex due to the problems that arise in the previous system.
Injection with a cam tracker when the application is on a shaped end. This is performed by dropping a bead of compound through a small-diameter nozzle supplied from a pressurised circuit via a cam trackers or a mechanical tracker the same shape as the end to enable the correct distribution of the compound.
   Such machines require careful control of the state of the nozzle, as in a few hours, blockages form that prevent the passage of the compound and cause the ends to be placed in the oven before the bead has been applied, thus rendered unusable. As the tracking is via cam, the compound is applied inconsistently around the perimeter.

Another of the major problems facing the end-lining industry is the change of format. For each machine, a specific format has to be designed, creating complex, inflexible mechanical parts for each end format change, which will require stopping and disassembling the machine and replacing the part.

As a result of the above, a machine is required that is capable of lining ends without the need for expensive maintenance and which in turn allows it to be adapted to any format and avoid the aforementioned need for disassembly and replacement of parts.

The use of a delta robot with an injection gun automates maintenance, enables the correct application of the compound and adapts to any end format by simply modifying the programming of its controller.

The delta robot is widely known today since it was created in the mid-1980s. It consists of three articulated arms with three servomotors attached at the end to a part (usually a clip) so that it can be moved smoothly and in a coordinated way to position the part at any coordinate of the robot's workspace. The problem with the end-lining application is that the system is based on friction bearings, which work at high speed and make continuous movements, heating up and suffering from premature wear and tear. That is why the use currently given to these robots is ‘pick&place’ (picking up and dropping objects).

With the positioning of the mechanisms referred to in this memorandum, however, the problems of using the delta robot for end-lining applications are resolved.

With regard to all the above, the author of this report is unaware of the existence of any device providing the described services or having a similar mechanism, whereby the invention is configured as an evident novelty. On this basis, the corresponding protection given to such inventions is requested.

### DESCRIPTION OF THE INVENTION

The machine resulting from the coupling of a traditional delta robot with the mechanical means described herein corresponds to a lining machine that applies the bead using an injection gun, where the robot programming includes the path to be covered by the gun, so that the injection system is extended to ends of any shape, not only round ones. The program also includes, at certain intervals of time, automatic cleaning of the gun tip and a purge program that cleans the entire gun when the machine stops, guaranteeing the cleaning of the equipment and thereby ensuring correct operation without the need for maintenance by an operator.

The mechanical assembly provided for the lining of ends by a delta robot comprises in broad terms three mechanical articulations connected at their upper ends to each of the respective servomotors with the platform supporting the injection gun that applies the bead of compound to the ends at the lower end thereof.

The articulations consist of a pair of arms whose ends have been machined to accommodate a stop articulated by a shaft running through it, resting on a pair of bearings arranged symmetrically on the faces of the machined sections. The bore made to accommodate the bearings has been done from the inside of the machining out so that, once inserted, the bearing is flush against the outer face of the end of the arm. Thus, each arm is joined to another symmetric rod by a pin with through-holes for the abovementioned shafts. At the lower end, they support the platform for the injection gun, while at the top they connect to the rods coupled to the delta robot servomotors. This connection is made using a reductive flange that transmits the movement of the servomotor to the rod.

The rods are also connected by the same shaft that joins the servomotors to safety cams positioned to limit the movements of the arms, preventing failure in the event of any faults arising from excessive movement of the equipment.

The platform for the injection gun is composed of three ends positioned at an angle of 120° to each other, with each one having a through-hole with the bolt that joins the lower ends to the arms. In the centre, a hole has been made for the base of the injection gun.

The injection gun will consist of a body that sits on the platform and ends in a nozzle that crosses said platform and protrudes at the bottom. The gun body has the holes needed to connect the pipes to supply the compound.

On the bench on which the various elements described in the preceding paragraphs are fixed, there will be a plate with a central hole through which the bead of compound will be applied to the ends supplied by the feeder. Said hole will be of sufficient size for lining the largest ends that are to be processed. Said plate will house a wire brush for cleaning the nozzle, so that when programmed, the gun will be displaced to said brush and the necessary movements will be made to clean the nozzle and thereby remove any traces of dry compound that may obstruct the outlet.

The delta robot servomotors will be supported by a base plate positioned at the top, supported by three pillars each positioned at an angle of 120°. Finally, the entire unit will be contained in a safety enclosure to prevent accidental access to the moving parts of the machine and the penetration of foreign elements in the lining process.

Another important advantage of the present invention is the possibility of incorporating the unit and the delta robot into any traditional lining machine, so that the elements that perform the lining are replaced but the other parts can still be used too, such as the feeder or the drying oven. Thus, the implementation of the machine in a factory is cheaper and also allows the use of discarded machinery.

### DESCRIPTION OF THE DRAWINGS

To complement the description that is being made and in order to facilitate better understanding of the specifications of the invention, illustrative, non-restrictive drawings are included as an integral part of this memorandum, described as follows:

FIG. 1 showing a perspective view of the unit incorporating the delta robot. This drawing and the following do not show the flexible pipe that carries the compound to the gun, leaving out said element to facilitate understanding of the drawing.

FIG. 2 showing a detail view of the connection through the rod and a support flange for the servomotor of the delta robot and the arms.

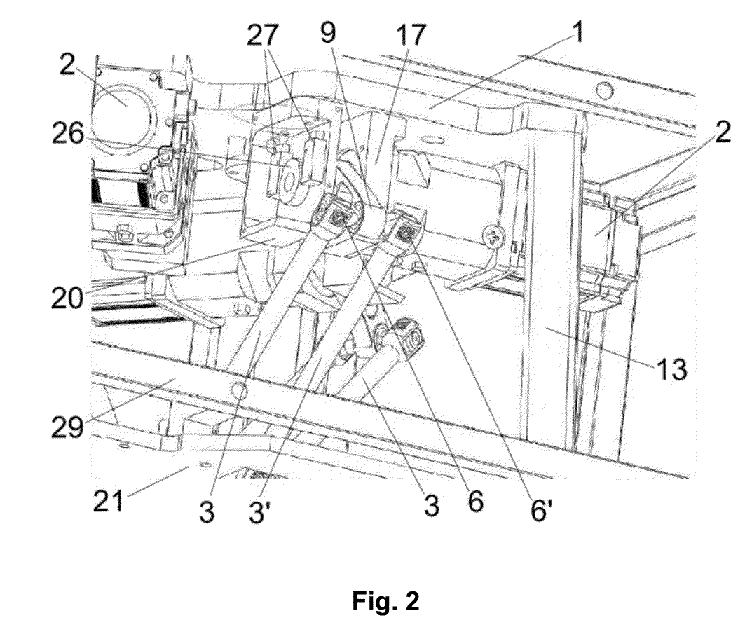

FIG. 3 showing the unit from a bottom view, representing the hole for the ends and, through the hole, the compound injection gun.

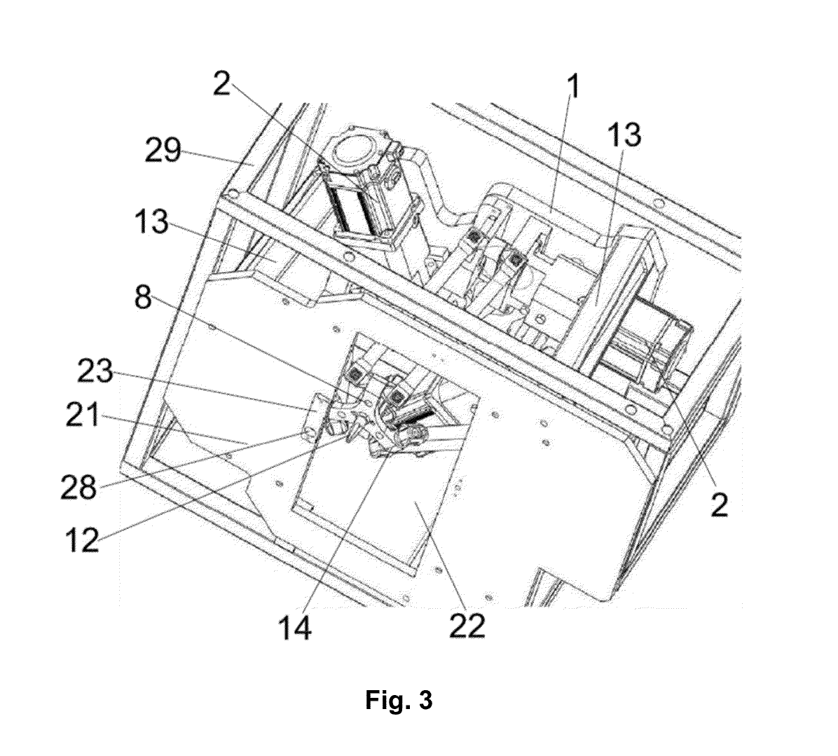

FIG. 4 showing another view with the safety cam that prevents arm movements outside a certain range. It also shows the coupling of the servomotor with the arms.

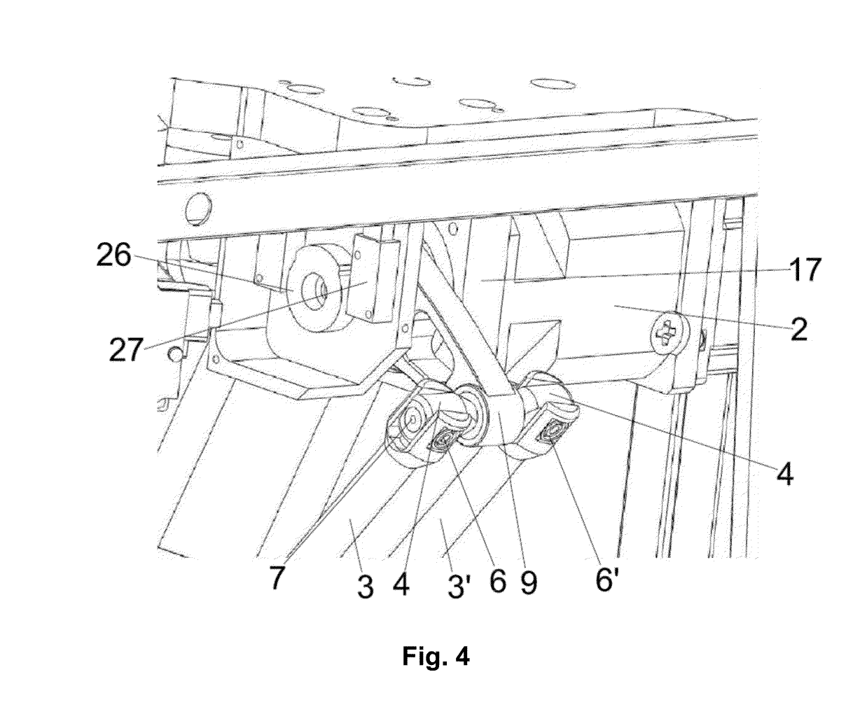

FIG. 5 showing the coupling of the arms with the platform through a set of bearings, shafts, bolts and stops equal to those of the upper part of the arm.

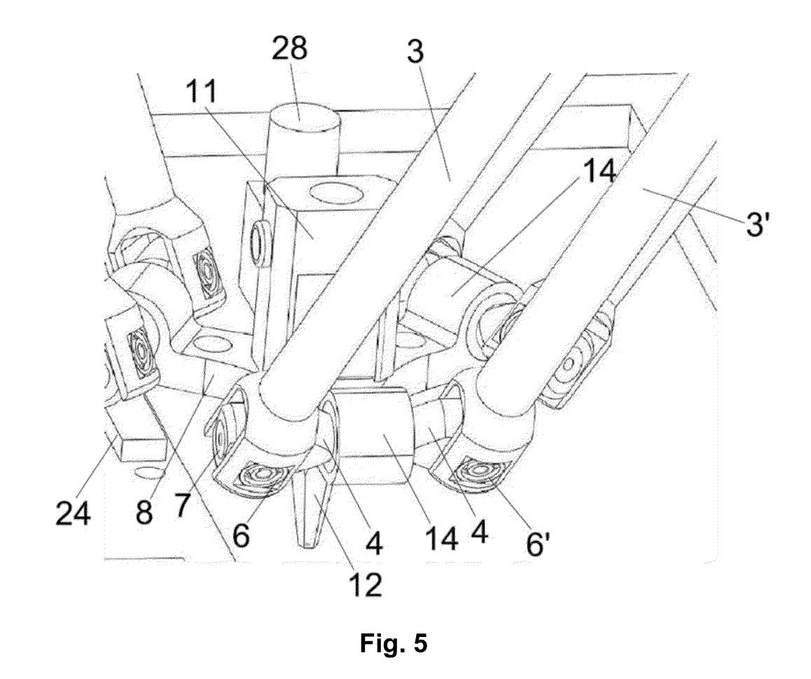

FIG. 6 showing the platform on which the injection gun is positioned.

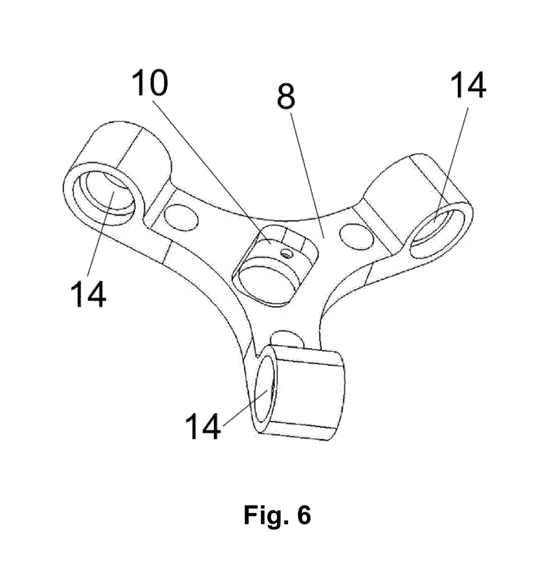

FIG. 7 showing a separate arm, with a clearer view of the inner bore that has been made. It also shows a stop, which is inserted in the machined section and, through the corresponding hole, a shaft has been inserted, connecting it to the rod or platform, depending on the end of the arm, where said shaft has the holes for the bolts that connect the bearings fitted in the inner bores. It is noted that the different parts shown are not on the same scale, but rather have been expanded in varying degrees for easy viewing.

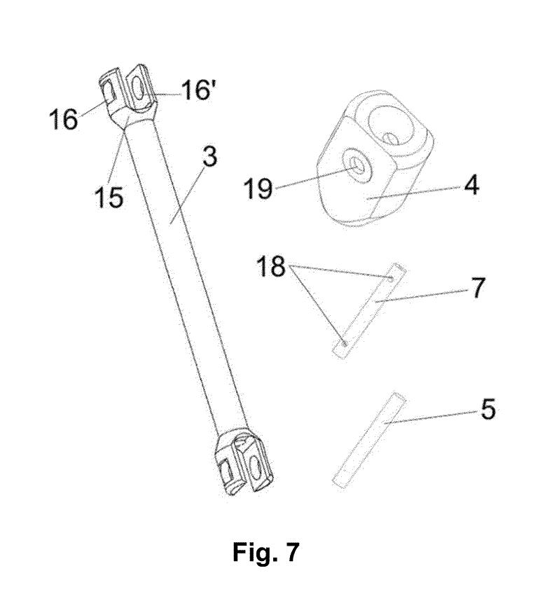

### DESCRIPTION OF THE PREFERRED REALISATION

In view of the aforementioned figures and according to the numbering system that is adopted, they show a preferred realisation of the invention, which comprises the parts and elements indicated and described in detail below, where this example does not aim to limit the scope thereof in any way.

The unit is anchored to a base plate (1) which in turn is supported by three pillars (13) positioned with an angular spacing of 120° between each one, so that there is space for positioning the remaining elements of the set of mechanical means for lining ends between said pillars (13).

Thus, three servomotors (2) are positioned in the traditional delta robot configuration (120° separation between each one) anchored at the bottom of the base plate (1) by their respective support flanges (17). The axles of the servomotors (2) are joined to the rods (9) by means of conical couplings, which in turn transmit movement to the arms (3, 3′) through a bolt (7) that passes through two separate stops (4) via a through-hole (19) and the cam (9) is connected to the bearings (6, 6′) thanks to the shafts (5) joining said bearings (6, 6′) through the respective shaft holes (18).

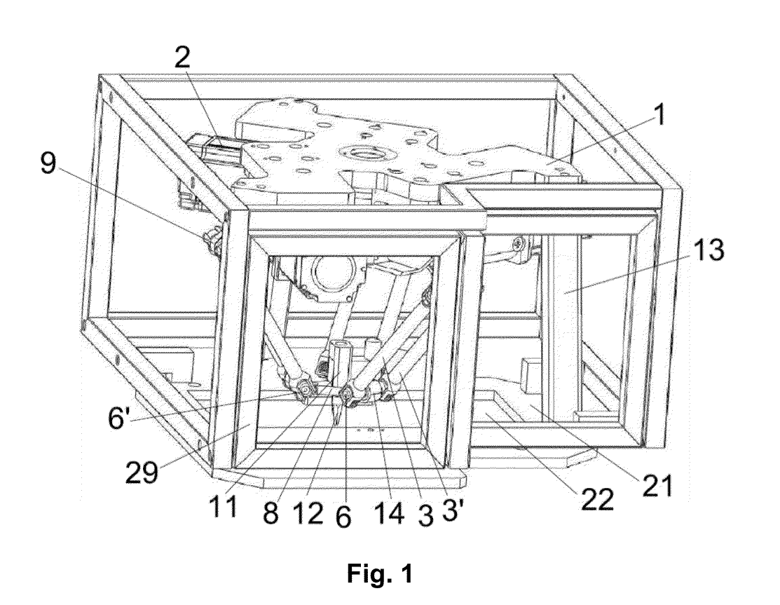

As shown in FIG. 1, the robot comprises a pair of arms (3, 3′) whose ends have a machined section (15) with rectangular geometry housing the stop (4) which secures the connection with the bolt (5). The bearings (6, 6′) are inserted on both sides of the machined section (15) through a bore (16) made from the inside out, so that the hole does not pass through completely and the bearings (6, 6′) are flush against the outer wall of the arm. This ensures a robust coupling without gaps capable of withstanding high movement speeds without wear and tear.

The connection between the rod (9) and the arms (3, 3′) will also have a lateral connection with a safety cam (26) whose mission is to accompany the movement of the rod (9) and limit the range of the arm movement, so that for any unexpected situation, excessive movements that may break the unit are avoided. The safety cam (26) will have safety stops (27) that restrict the range of rotation of said safety cam (26). The safety cam (26) is positioned in a casing box (20) which separates it from the other elements.

The coupling of the arms (3, 3′) by means of a pin (7) and stops (4) is repeated at both the top and the bottom. At the bottom, it is attached to the platform (8), which has three ends arranged with a 120° separation between each one and they all have a through-hole (14) for the bolt (7). In the centre of the platform, there is another hole for positioning the gun (10) which will house the injection gun body (11), into which the compound will be fed under pressure for it to come out at the injector nozzle (12).

The pillars (13) supporting the base plate (1) will be positioned on a bottom plate (21) with a central hole (22) of sufficient size to allow access by the injector nozzle (12) to the ends the feeder will position under said central hole (22). Thus, it will only be necessary to mount the bottom plate (21) on the bench of any machine using the systems referred to in the background section from which the lining parts have been removed to enable the implementation of the unit described in this memorandum, with the aforementioned benefits this entails.

The bottom plate (21) will also have a base (23) for a wire cleaning brush (24). A self-cleaning process programmed into the robot moves the injection nozzle (12) to the position of the cleaning brush (24). By means of a repetitive movement, it applies pressure to the brush (24) and the nozzle (12) is cleaned completely, preventing obstructions that could cause deviations on the compound outlet, staining the cover. Once the nozzle has been cleaned (12), it will move to a drain (28) for automatic purge so that the process can be resumed with all elements completely clean. Also, before a stop or a shift change during which the lining operation is expected to stop for an extended period, the nozzle (12) will be moved to the drain (28) and a jet of treated water will be passed through it to completely clean the inside of the gun body (11) and the injector nozzle (12), leaving both completely clean and ready for a restart when required.

The gun body (11) will have connections for the inlet pipe for the injected compound. The pipe will be flexible and long enough to follow the movements of the platform (8) without interruption.

The entire unit described above will be covered by a protective casing (29) to prevent the penetration of foreign particles in the process and accidental access by workers to the moving parts of the mechanisms. Said casing (29) will also rest on the bottom plate (21).

Having described the nature of this invention sufficiently, together with its implementation, it is not considered necessary to give a further explanation for any expert in the art to understand its scope and the benefits it provides, stating that, in its essence, it may be implemented via other realisations that differ in detail from that indicated by way of example, and which will also offer the protection indicated as long as its fundamental principle is not altered, changed or modified.

1.-7. (canceled)

8. A robot for lining ends, the robot comprising:
three servomotors positioned with an angular spacing of about 120° and attached to a base plate, wherein the base plate stands on multiple pillars which rest on a bottom plate that is configured to be positioned on an end feeder bench, wherein at an output of each of the three servomotors is coupled with a conical fastening to a rod that is configured to transmit movement to a symmetrical pair of arms connected a first end to the rod with a bolt, wherein the bolt passes through a first stop via a first through-hole and the rod is connected to bearings by a shaft that joins the bearings through a shaft hole, wherein the first end of each of the symmetrical pair of arms comprises a first machined section having a substantially rectangular geometry that houses the first stop and that is configured to secure a connection to the bolt while the bearings are inserted on both sides of the machined section through a bore made from the inside out, such that the bore is not complete and the bearings fit flush against an outer wall of each of the symmetrical pair of arms, wherein a second end of each of the symmetrical pair of arms comprises a second machined section having the substantially rectangular geometry and housing a second stop, and wherein the second end of each of the symmetrical pair of arms is coupled by a pin with a platform, which has three ends positioned with about a 120° angular spacing between each of the three ends, with a second through-hole for the pin.

9. The robot of claim 1, wherein the rod connecting to the symmetrical pair of arms comprises a lateral connection to a safety cam that is configured to rotate with the rod and to be accompanied by a safety stop that is configured to limit a range of rotation of the safety cam.

10. The robot of claim 1, wherein the platform defines a hole, wherein an injection gun is fitted on the platform such that an injector nozzle extends through the hole.

11. The robot of claim 1, wherein the bottom plate comprises a central hole of sufficient size to allow an injector nozzle supported by the platform to apply a material to an end of an object positioned under said central hole, wherein the bottom plate further comprises a brush configured to clean the injector nozzle.

12. The robot of claim 3, wherein the brush is positioned such that it allows the injection nozzle to move towards a position of the brush and to perform a reciprocating movement to apply pressure to the brush.

13. The robot of claim 1, further comprising a drain, wherein the drain is configured to shoot a jet of treated water on an injector nozzle supported by the platform when the nozzle is moved over the drain.

14. The robot of claim 1, wherein the robot is covered by a protective casing that rests on the bottom plate.

15. The robot of claim 2, wherein the robot is covered by a protective casing that rests on the bottom plate.

16. The robot of claim 3, wherein the robot is covered by a protective casing that rests on the bottom plate.

17. The robot of claim 4, wherein the robot is covered by a protective casing that rests on the bottom plate.

18. The robot of claim 1, wherein the bottom plate comprises a central hole of sufficient size to allow an injector nozzle supported by the platform to apply a material to an end of an object positioned under said central hole, wherein the bottom plate further comprises a brush configured to clean the injector nozzle.
